(19) United States
(12) Patent Application Publication
(10) Pub. No.: US 2004/0258901 A1
(43) Pub. Date: Dec. 23, 2004

(54) Gypsum plaster

(75) Inventors: Lydia Luckevich, Toronto (CA); Peter Mayer, Mississauga (CA); Jason Davies, Milford Haven (GB)

Correspondence Address: BIRCH STEWART KOLASCH & BIRCH, PO BOX 747, FALLS CHURCH, VA, 22040-0747, US

(73) Assignee: BPB PLC.

(21) Appl. No.: 10/823,783

(22) Filed: Apr. 14, 2004

Related U.S. Application Data
(63) Continuation of application No. 09/673,796, filed on Dec. 22, 2000, now abandoned.
Application No. 09/673,796 is a 371 of international application No. PCT/GB99/01198, filed on Apr. 20, 1999.

(30) Foreign Application Priority Data
Apr. 20, 1998 (GB) 9808339.7

(51) Int. Cl. B32B 25/10

(52) U.S. Cl. 428/297.1

(57) ABSTRACT

An extrudable gypsum plaster paste is disclosed comprising: α gypsum plaster, water in a substantially stoichiometric amount; a binder; and a clay or another rheology modifier functionally equivalent to a clay. Such pastes can have a yield stress sufficient to make the paste self supporting. The invention also provides a method for making an extrudable gypsum plaster paste comprising: mixing α gypsum plaster, water in a substantially stoichiometric amount and a binder; and mixing into that mixture a clay or other rheology modifier functionally equivalent to a clay.

This application is a continuation of application Ser. No. 09/673,796, which is the national phase under 35 U.S.C. § 371 of PCT International Application No. PCT/GB99/01198 which has an International filing date of Apr. 20, 1999, which designated the United States of America.

The invention relates to the production of formed gypsum products and to a composition therefor.

Gypsum plaster, calcium sulphate hemihydrate, is generally formed by the calcining of gypsum, calcium sulphate dihydrate, although it may be formed in other ways. On addition of water, gypsum plaster rehydrates to gypsum and can be formed into a coherent body. Gypsum plaster requires 18.6% water by weight of plaster to fully rehydrate it.

In the conventional production of formed gypsum products, plaster is mixed with an excess of water to form a slurry of a creamy, pouring, consistency. The slurry may contain setting control agents and other additives such as fibres and lightweight aggregates. The slurry is fed onto a continuous belt and as it sets it is constrained into the desired shape. The set formed product contains water, since an excess was used to form the slurry; the formed product must be dried by heating, at considerable cost, since set plaster containing as little as 5% by weight free water has very low strength.

Attempts have been made to form plaster products from a plaster/water mix containing only slightly more than the stoichiometric amount of water, to reduce the energy needed to dry the formed product. It has not proved possible heretofore to provide such a mix having satisfactory rheology to enable it to be formed, for example by extrusion; the mixture tends to be friable and does not produce a satisfactorily smooth surface to the formed product. This is in part because since the mixture is not fluid, adequate mixing of the water with the plaster is not achieved. This leaves pockets of unrehydrated plaster and an excess of water elsewhere.

It has now been found that an extrudable gypsum plaster paste can be formed using a stoichiometric or close to stoichiometric amount of water.

According to a first aspect of the invention there is provided a gypsum plaster paste comprising:

α gypsum plaster;

water in a substantially stoichiometric amount (as herein defined);

a binder; and

a clay or another rheology modifier functionally equivalent to a clay.

Also according to the first aspect of the invention there is provided a method for making a gypsum plaster paste comprising:

mixing α gypsum plaster, water in a substantially stoichiometric amount (as herein defined) and a binder; and

mixing into that mixture a clay or other rheology modifier functionally equivalent to a clay.

According to a second aspect of the invention there is provided a gypsum plaster paste comprising:

α gypsum plaster;

water in a substantially stoichiometric amount (as herein defined);

a binder; and

a rheology modifier such that the paste has a yield stress sufficient to make the paste self supporting. Preferably, the rheology modifier is a clay. Preferred binders are cellulosic binders. The stoichiometric amount of water is that amount needed to achieve complete rehydration of the plaster from the hemihydrate to the dihydrate, and no more. Preferably, the paste contains only α gypsum plaster. The paste may include an extrusion aid. Preferably, the clay or other rheology modifier is present in an amount up to 20%, preferably of from 10 to 12% for extrusion purposes by weight of plaster.

Also according to the second aspect of the invention there is provided a method for making a gypsum plaster paste:

mixing α gypsum plaster, water in a substantially stoichiometric amount (as herein defined) and a binder; and

mixing into that mixture a rheology modifier such that the paste has a yield stress sufficient to make the paste self supporting. Preferred rheology modifiers are clays.

Preferred cellulosic binders are cellulose ethers; particularly preferred are those having a molecular weight between 12000 and 30000. Other suitable binders include polyvinylalcohol (PVA) and polyethyleneglycol (PEG), either alone or in combination. Preferably, the binder is present at a level of at least 0.1%, and more preferably at least 1%, by weight. Preferably, the binder is present at a level of no more than 10%, more preferably no more 5%, by weight of plaster.

The binder, preferably a cellulosic binder, is preferably suspended in the water before it is mixed with the gypsum plaster. An extrusion aid may be included in the plaster/water mixture before mixing with the clay.

It is preferred that the water content of the mixture is between 13% and 32% based on the weight of α plaster. This corresponds to between 70% and 170% of the stoichiometric amount. In pastes containing less than the stoichiometric amount of water the unrehydrated plaster acts as a filler; in contrast to other proposed processes using near stoichiometric amounts of water, the water and the unrehydrated plaster is easily dispersed throughout the paste and there is virtually no free water in the paste. It is preferred that a retarder such as diethyl triamine pentacetic acid (DTPA) is employed as a retarder to prevent the paste from setting during processing. Alternatively, elevated temperatures preferably above 60° C. can be employed; at such temperatures, the plaster will not set, allowing the mixture to be mixed thoroughly and avoiding the plaster setting in the mixer or elsewhere in the process.

A preferred clay is Grolleg English china clay, but other clays may be used; examples of other clays are ball, atapulgous and bentonitic clays. The rheological effect of clays and other rheology modifiers on the paste will differ depending on the type of clay or other modifier employed. Those skilled in the art will be able to select an appropriate clay or other modifier to achieve a desired rheology, using if necessary simple experimentation.

The paste of the invention is particularly suitable for forming into a desired shape by extrusion. Although the paste is self supporting it will normally be necessary to support the formed paste immediately as it leaves the die, for example on a moving belt. The extended product can be cut to length before or after setting.

Alternatively, the paste can be formed into product by other plastic forming processes such as pressing, stamping, rolling and injection moulding.

In the context of the present invention, yield stress is the stress which must be exceeded in order to cause measurable flow in the paste. The measured yield stress will be different depending on the processing to which the paste is subjected, such as extrusion or rolling. Yield stress is measured using standard rheological techniques such as by use of a controlled stress rheometer.

It has been found that products made from pastes according to the invention exhibit excellent strength and hardness. Extruded product made from a paste according to the invention can exhibit average flexural strength (measured according to ASTM C78) of 10 to 30 M Pa. This may be due to the excellent rheological properties of the paste allowing formation of a product substantially free of macro defects, especially by extrusion.

The inclusion in the paste of lightweight aggregates, preferably up to 20% by weight of, allows the density of the formed product to be reduced to 1.5 g/ml or lower. Preferred aggregates include lightweight ceramic microspheres, and cenospheres.

Fibres may be added to the paste, preferably up to 10% by weight of plaster. Preferred fibres included glass and polypropylene fibres.

The invention will be further described with reference to the following example:

| | Parts by Weight |
|---|---|
| DTPA (setting retarder) 41% solution: | 0.66% |
| methylcellulose (Methocel A4M) : | 3.18% |
| water: | 96.16% |

The pre-gel/suspension was used to make the following composition:

| | Parts by Weight |
|---|---|
| α gypsum plaster: | 84.28% |
| pre-gel/suspension | 15.6% |
| DTPA (setting retarder) 41% solution | 0.12% |

This composition was mixed in a Z-blade mixer at ambient temperature for about 4 minutes. To this composition was added 9.82% by weight of the total mixture Grolleg English china clay and the resulting mixture was mixed for a further 3 minutes until the resulting paste was sufficiently plastic to be extruded. The paste was then removed from the mixer and introduced into the pugging section of a Kema extruder. It was then deaired in the vacuum section of the extruder and extruded through a die, the extruded paste being supported on a conveyor as it exited the die. The extruded products were cut to length before they set.

The density of the extruded product was 2.09 g/ml. The Rockwell hardness was 119 and the modulus of rupture 11.5 M Pa. In other examples, a modulus of rupture of up to 25 M Pa has been achieved.

1. An extruded, stamped, pressed, rolled or injection molded gypsum plaster product made from a paste comprising:
α gypsum plaster;
water in an amount of from 70% to 170% of the stoichiometric amount:
a binder; and
a clay or another rheology modifier functionally equivalent to a clay,
the product being substantially free of macro defects.

2. An extruded, stamped, pressed, rolled or injection molded gypsum plaster product made from a paste comprising:
α gypsum plaster;
water in an amount of from 70% to 170% of the stoichiometric amount,
a binder; and
a rheology modifier such that the paste has a yield stress sufficient to make the paste self supporting,
the product being substantially free of macro defects.

3. A product according to claim 2 in which the rheology modifier is a clay.

4. A product according to claim 1 in which the rheology modifier is present in the said paste in an amount of up to 20% weight of plaster.

5. A product according to claim 1 in which all the gypsum plaster is α gypsum plaster.

6. A product according to claim 1 in which the water is present in the said paste in an amount of from 13% to 32% by weight of plaster.

7. A product according to claim 1 in which the binder is a cellulosic binder.

8. A product according to claim 1 in which the binder is at least one of polyvinylalcohol and polyethyleneglycol.

9. A product according to claim 1 in which the binder is present in an amount of at least 0.1% by weight.

10. A product according to claim 1 in which the binder is present in an amount of no more than 10% by weight.

11. The product according to claim 1, further comprising a component selected from the group consisting of setting retarder, lightweight aggregate and fiber.

12. A product according to claim 11 in which the lightweight aggregate is ceramic microspheres or cenospheres.

13. A product according to claim 11 in which the lightweight aggregate is present in an amount of up to 20% by weight.

14. A product according to claim 11 in which the fiber is glass or polypropylene fiber.

15. A product according to claim 11 in which the fiber is present in an amount of up to 10% by weight.

16. The product according to claim 11, in which the water is present in said paste in an amount of from 13% to 32% by weight of a plaster.

17. A method for making a gypsum plaster product according to claim 1 comprising forming a paste by:
mixing α gypsum plaster, water in an amount of from 70% to 170% of the stoichiometric amount and a binder:
mixing into that mixture a clay or other rheology modifier functionally equivalent to a clay;
working the paste into a plastic condition; and extruding, stamping, pressing or injection molding the paste to form a shaped product.

18. A method for making a gypsum plaster product according to claim 2 comprising forming a paste by:
mixing α gypsum plaster, water in an amount of from 70% to 170% of the stoichiometric amount and a binder;
mixing into that mixture a rheology modifier such that the paste has a yield stress sufficient to make the paste self supporting;
working the paste into a plastic condition; and
extruding, stamping, pressing or injection molding the paste to form a shaped product.

19. A method according to claim 18 in which a clay is mixed into the said mixture as the rheology modifier.

20. A method according to claim 17, further comprising forming a pre-gel/suspension comprising water and binder and adding α gypsum plaster to the pre-gel/suspension.

21. A method according to claim 17 further comprising adding a setting retarder to the composition.

22. A method according to claim 17 carried out at a temperature above 60° C.

23. A method according to claim 17 in which the paste is extruded after working and in which the extruded paste is supported as it leaves the die.

24. A gypsum plaster paste comprising:
α gypsum plaster;
water in an amount of from 70% to 170% of the stoichiometric amount;
a binder; and
a rheology modifier such that the paste has a yield stress sufficient to make the paste self supporting,
the product being substantially free of macro defects.

25. A paste according to claim 24 in which the rheology modifier is a clay.

26. A product according to claim 1 in which the binder is present in an amount of at least 1% by weight.

27. A product according to claim 1 in which the binder is present in an amount of no more than 5% by weight.

28. An extruded, stamped, pressed, rolled or injection molded gypsum plaster product made from a paste comprising:
α gypsum plaster;
water in an amount of from 70% to 170% of the stoichiometric amount:
a binder; and
a clay or another rheology modifier functionally equivalent to a clay,
the product being substantially free of macro defects wherein said paste is made by
mixing α gypsum plaster, water in an amount of from 70% to 170% of the stoichiometric amount and a binder;
mixing into that mixture a rheology modifier such that the paste has a yield stress sufficient to make the paste self supporting;
working the paste into a plastic condition; and
extruding, stamping, pressing or injection molding the paste to form a shaped product.

29. A product according to claim 2 in which the binder is at least one of polyvinylalcohol and polyethyleneglycol.

30. A product according to claim 3 in which the binder is at least one of polyvinylalcohol and polyethyleneglycol.

31. A product according to claim 4 in which the binder is at least one of polyvinylalcohol and polyethyleneglycol.

32. A product according to claim 5 in which the binder is at least one of polyvinylalcohol and polyethyleneglycol.

33. A product according to claim 6 in which the binder is at least one of polyvinylalcohol and polyethyleneglycol.

34. A product according to claim 7 in which the binder is at least one of polyvinylalcohol and polyethyleneglycol.

35. A method according to claim 18 in which the paste is extruded after working and in which the extruded paste is supported as it leaves the die.
